(19) United States
(12) Patent Application Publication
(10) Pub. No.: US 2016/0328770 A1
(43) Pub. Date: Nov. 10, 2016

(54) PERSONALIZATION OF PRODUCTS FOR 3D PRINTING

(71) Applicant: Ocean Print Limited, Dublin 2 (IE)

(72) Inventor: Shane Hassett, Abbeyfeale (IE)

(21) Appl. No.: 14/703,700

(22) Filed: May 4, 2015

(51) Int. Cl. G06Q 30/06

(52) U.S. Cl. CPC G06Q 30/0621

(57) ABSTRACT

Systems, methods, apparatuses, and computer program products for personalizing 3D printed objects or products are provided. One method includes setting, by at least a processor, at least one customization parameter that describes an aspect of a three dimensional (3D) product that is available to be customized by a customer, and displaying, via a web application, the at least one customization parameter and limits for the at least one customization parameter. The web application is linked to a product file containing a representation of the 3D product. The method may further include receiving user selections for the at least one customization parameter, applying the user selections to the product file to customize the 3D product, and streaming the product file with the applied user selections to a 3D printer.

### BACKGROUND

1. Field

Embodiments of the invention generally relate to 3D printing or additive manufacturing. In particular, some embodiments relate to methods and systems for personalizing or modifying 3D products.

2. Description of the Related Art

3D printing or additive manufacturing may refer to processes used to make a three-dimensional object. 3D printing may utilize additive processes in which successive layers of material are placed down under the control of a computer. The process may be performed by a 3D printer, which is essentially a type of industrial robot. 3D printed objects may be basically of any shape or geometry, and may be produced from a 3D model or other electronic data source.

3D printable models may be created with a computer aided design (CAD) package, a 3D scanner, a plain digital camera and/or photogrammetry software. 3D scanning is a process of analyzing and collecting digital data on the shape and appearance of a real object. Based on this data, three-dimensional models of the scanned object can then be produced.

However, there is a need for a procedure to easily enable customers to personalize 3D products.

### SUMMARY

One embodiment is directed to a method, which may include setting, by at least a processor, at least one customization parameter that describes an aspect of a three dimensional (3D) product that is available to be customized by a customer. The method may also include displaying, for example via a web application, the at least one customization parameter and limits for the at least one customization parameter. The web application may be linked to a product file containing a representation of the 3D product. The method may then include receiving user selections for the at least one customization parameter, applying the user selections to the product file to customize the 3D product, and streaming the product file with the applied user selections to a 3D printer.

Another embodiment is directed to an apparatus, which may include at least one processor, and at least one memory storing computer program code including a 3D product personalization module. The at least one memory and the 3D product personalization module, with the at least one processor, cause the apparatus at least to set at least one customization parameter that describes an aspect of a three dimensional (3D) product that is available to be customized by a customer, and to display the at least one customization parameter and limits for the at least one customization parameter. The web application is linked to a product file containing a representation of the 3D product. The at least one memory and the 3D product personalization module, with the at least one processor, may further cause the apparatus at least to receive user selections for the at least one customization parameter, apply the user selections to the product file to customize the 3D product, and stream the product file with the applied user selections to a 3D printer.

Another embodiment is directed to a computer program, embodied on a non-transitory computer readable medium. The computer program may be configured to control a processor to perform a process that may include setting at least one customization parameter that describes an aspect of a three dimensional (3D) product that is available to be customized by a customer. The process may also include displaying the at least one customization parameter and limits for the at least one customization parameter. The web application may be linked to a product file containing a representation of the 3D product. The process may then include receiving user selections for the at least one customization parameter, applying the user selections to the product file to customize the 3D product, and streaming the product file with the applied user selections to a 3D printer.

In an embodiment, the setting of the at least one customization parameter may further comprise setting options and extent to which 3D product is able to be customized. According to certain embodiments, the at least one customization parameter may comprise at least one of scale, color, material, and/or accessories. In one embodiment, the displaying may comprise displaying the at least one customization parameter on a retail website.

### BRIEF DESCRIPTION OF THE DRAWINGS

For proper understanding of the invention, reference should be made to the accompanying drawings, wherein:

FIG. 1 illustrates an apparatus according to one embodiment of the invention;

FIG. 2 illustrates an example webpage displaying an embodiment of the invention; and

FIG. 3 illustrates a flow diagram of a method, according to an embodiment of the invention.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for personalizing 3D printed objects or products, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Certain embodiments are directed to a system and/or method for personalizing or customizing a 3D product by an end consumer before purchasing, where the customization is performed within the limits set by the product owner/producer. Accordingly, embodiments allow for changes to a 3D product to meet the end consumer expectations and requirements.

In one embodiment, a product owner or retailer sets the parameters for which their product may be personalized. These personalization parameters may include but are not limited to, for example, scale, color, accessories, materials and/or ingredients. According to an embodiment, the personalization parameters and limits may be displayed for manipulation on a web application embedded on a retail site and linked to the 3D product file. The consumer may then adjust the personalization parameters to meet their own requirements and taste. A personalization tool, according to embodiments, may then apply the consumer's personalization parameters to the original file that includes the model of the 3D product, which is then streamed to the 3D printer after purchase.

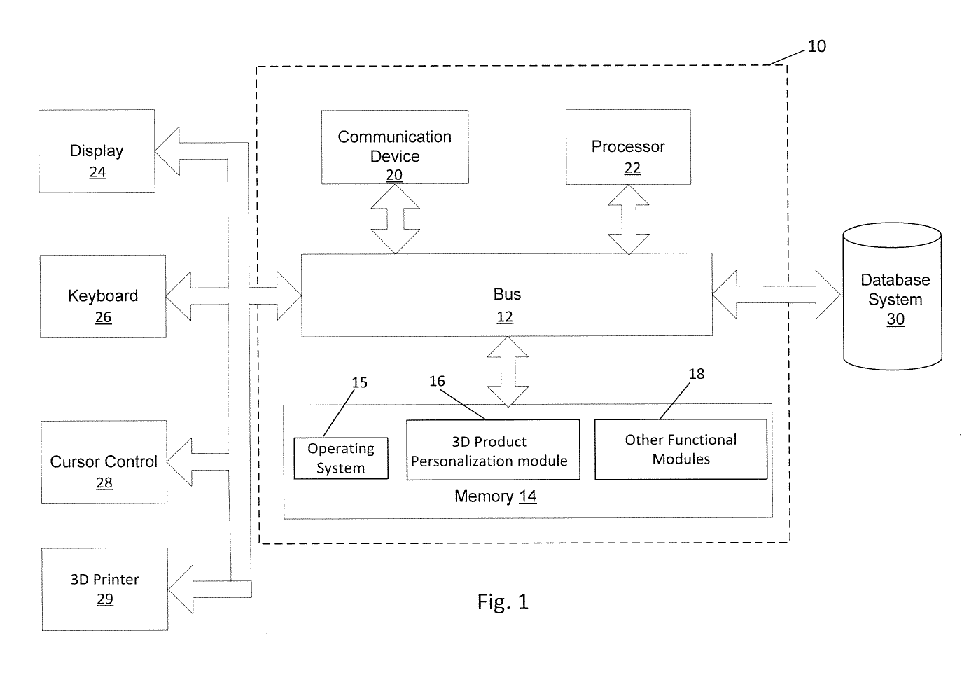

FIG. 1 illustrates a block diagram of an apparatus 10 configured to implement a 3D product personalization system, according to one embodiment. In certain embodiments, apparatus 10 may be a server, such as an application server. Apparatus 10 may include a bus 12 or other communications mechanism for communicating information between components of apparatus 10. Alternatively, the components of apparatus 10 may communicate with each other directly without the use of bus 12.

Apparatus 10 may also include a processor 22, coupled to bus 12, for processing information and executing instructions or operations. Processor 22 may be any type of general or specific purpose processor. Apparatus 10 may further include a memory 14 for storing information and instructions to be executed by processor 22. Memory 14 may be comprised of any combination of random access memory (RAM), read only memory (ROM), static storage such as a magnetic or optical disk, or any other type of machine or computer readable media.

Apparatus 10 may further include a communication device 20, such as a network interface card or other communications interface, to provide access to a network. As a result, a user may interface with apparatus 10 directly or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data, and may include any other form of information delivery medium known in the art. A storage medium may include RAM, flash memory, ROM, erasable programmable read-only memory (EPROM), electrically erasable programmable read-only memory (EEPROM), registers, hard disk, a removable disk, a compact disk read-only memory (CD-ROM), or any other form of storage medium known in the art.

Processor 22 may be further coupled, for example via bus 12, to a display 24. Display 24 may be, for instance, a Liquid Crystal Display (LCD), Light Emitting Diode (LED), or any other current or future display technology capable of displaying information or data to a user, such as product information, as will be discussed in more detail below. In some embodiments, a keyboard 26 and a cursor control device 28, such as a computer mouse, may be further coupled to bus 12 to enable a user to interface with apparatus 10. Also, in an embodiment, processor 22 and memory 14 may be coupled, for example via bus 12, to a 3D printer 29 capable of performing additive manufacturing processes.

Processor 22 and memory 14 may also be coupled via bus 12 to a database system 30 and, thus, may be able to access and retrieve information stored in database system 30. Although only a single database is illustrated in FIG. 1, any number of databases may be used in accordance with certain embodiments. In some embodiments, database system 30 may store information related to 3D products and personalization or customization parameters for the 3D product, as well as any other relevant information.

In one embodiment, memory 14 stores software modules that provide functionality when executed by processor 22. The modules may include an operating system 15 that provides operating system functionality for apparatus 10. The memory may also store a 3D product personalization module 16, which can provide the functionality for personalizing or customizing a 3D product prior to its production or printing. In some embodiments, 3D product personalization module 16 may be considered a web application stored in apparatus 10, which may be an application server. Apparatus 10 may also include one or more other functional modules 18 to provide additional functionality.

Database system 30 may include a database server and any type of database, such as a relational or flat file database. Database system 30 may store attributes and/or customization parameters related to 3D products. Database system 30 may also store any other data required by the 3D product personalization module 16, or data associated with apparatus 10 and its associated modules and components.

In certain embodiments, 3D product personalization module 16, and other functional modules 18 may be implemented as separate physical and logical units or may be implemented in a single physical and logical unit. Furthermore, in some embodiments, 3D product personalization module 16, and other functional modules 18 may be implemented in hardware, or as any suitable combination of hardware and software.

In one embodiment, memory 14 and 3D product personalization module 16, with processor 22, may be configured to control apparatus 10 to set at least one customization parameter that describes an aspect of a three dimensional (3D) product that is available to be customized by a customer. The setting of the at least one customization parameter may include setting the options, their range and the extent to which 3D product is able to be customized.

As an example, the customization parameter(s) may include at least one of scale, color, material, and/or accessories. For instance, the customization parameter may indicate that the scale can be changed and indicate the range of sizes that the scale can be changed to. Or in the case of color, the customization parameter may indicate that the color can be changed and also provide the specific colors that are available for the 3D product. As a result, the product owner or retailer is able to set the personalization parameters of the product to match their business model, standard requirements, and product range requirements.

In an embodiment, memory 14 and 3D product personalization module 16, with processor 22, may be further configured to control apparatus 10 to display the at least one customization parameter and limits for the at least one customization parameter, where the 3D product personalization module 16 is linked to a product file containing a representation of the 3D product. For example, the product file may be a computer aided design (CAD) software file that models the 3D product. In an embodiment, the displaying of the at least one customization parameter may include displaying the at least one customization parameter on a retail website or e-commerce site, such as Amazon®.

In certain embodiments, memory 14 and 3D product personalization module 16, with processor 22, may then be configured to control apparatus 10 to receive user selections for the at least one customization parameter, apply the user selections to the product file (e.g., CAD file) to customize the 3D product, and stream the product file with the applied user selections to a 3D printer.

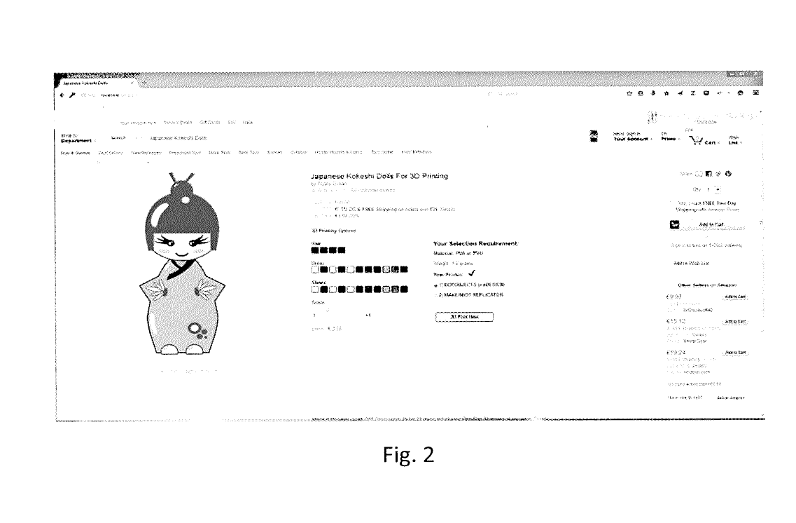

FIG. 2 illustrates an example of an application of an embodiment of the present invention to the graphical user interface of a retailer website. In an embodiment, the 3D personalization module is stored and run on an application server of the website. In an embodiment, the 3D product provider/seller may select or sets the desired personalization parameters that may be adjusted by a user. Then, when the 3D product page is accessed by a user, the 3D personalization module provides those personalization parameters to the user.

In the example of FIG. 2, the 3D product, which in this case is a doll, is available for purchase. Prior to 3D printing, embodiments of the invention provide several customization options of the doll prior to its printing. As mentioned above, the personalization parameters and limits are displayed for manipulation on the web application embedded on the retail website and linked to the product file. In the example of FIG. 2, the personalization parameters allow the customer to customize the hair color, dress color, shoe color, as well as the scale and material (e.g., PVA or PVU). The consumer adjusts the personalization parameters to meet their own requirements and taste. Once the consumer completes their selections of the personalization parameters and selects the “3D Print Now” button, the 3D personalization module applies the consumer's parameters to the original 3D product file, which is then streamed to the 3D printer after purchase.

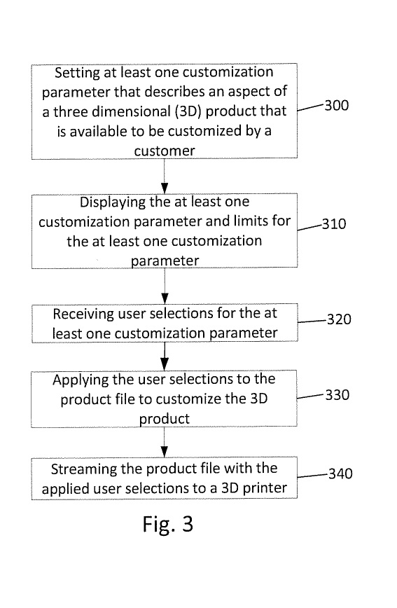

FIG. 3 illustrates an example flow diagram of a method, according to one embodiment of the invention. In certain embodiments, the method of FIG. 3 may be performed by a server which may comprise a processor and memory storing a web application. In the example of FIG. 3, the method may include, at 300, setting, for example by at least the processor, at least one customization parameter that describes an aspect of a 3D product that is available to be customized by a customer. The setting of the at least one customization parameter may include setting options and extent to which 3D product is able to be customized. In some embodiments, the at least one customization parameter may refer to at least one of scale, color, material, and/or accessories.

The method may then include, at 310, displaying, via the web application, the at least one customization parameter and limits for the at least one customization parameter. In some embodiments, the displaying may include displaying the at least one customization parameter on a retail or e-commerce website. The web application may be linked to a product file containing a representation of the 3D product. The method may further include, at 320, receiving user selections for the at least one customization parameter. At 330, the method may include applying the user selections to the product file to customize the 3D product and, at 340, streaming the product file with the applied user selections to a 3D printer. The 3D printer may then print the 3D product in accordance with the user selections of the customization parameters.

In some embodiments, the functionality of any method described herein, such as that of FIG. 3, may be implemented by software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software. The computer readable media mentioned above may be, for example, at least partially embodied by a transmission line, a compact disk, digital-video disk, a magnetic disk, holographic disk or tape, flash memory, magnetoresistive memory, integrated circuits, or any other digital processing apparatus memory device.

Embodiments of the invention may provide several advantages and/or technical improvements. For example, embodiments are able to achieve a higher satisfaction level for the end consumer, adapt the product to personal needs, and offer wider product portfolio without additional costs to the product owner. In addition, embodiments are easily embedded into a 3D product owner or retailer website, and the interface does not interfere with the current consumer experience of an e-commerce site.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
setting, by at least a processor, at least one customization parameter that describes an aspect of a three dimensional (3D) product that is available to be customized by a customer;
displaying, via a web application, the at least one customization parameter and limits for the at least one customization parameter, wherein the web application is linked to a product file containing a representation of the 3D product;
receiving user selections for the at least one customization parameter;
applying the user selections to the product file to customize the 3D product; and
streaming the product file with the applied user selections to a 3D printer.

2. The method according to claim 1, wherein the setting the at least one customization parameter further comprises setting options and extent to which 3D product is able to be customized.

3. The method according to claim 1, wherein the at least one customization parameter comprises at least one of scale, color, material, and accessories.

4. The method according to claim 1, wherein the displaying comprises displaying the at least one customization parameter on a retail website.

5. An apparatus, comprising:
at least one processor;
at least one memory storing computer program code including a 3D product personalization module;
wherein the at least one memory and the 3D product personalization module, with the at least one processor, cause the apparatus at least to set at least one customization parameter that describes an aspect of a three dimensional (3D) product that is available to be customized by a customer;
display the at least one customization parameter and limits for the at least one customization parameter, wherein the web application is linked to a product file containing a representation of the 3D product;
receive user selections for the at least one customization parameter;
apply the user selections to the product file to customize the 3D product; and
stream the product file with the applied user selections to a 3D printer.

6. The apparatus according to claim 5, wherein the setting the at least one customization parameter further comprises setting options and extent to which 3D product is able to be customized.

7. The apparatus according to claim 5, wherein the at least one customization parameter comprises at least one of scale, color, material, and accessories.

8. The apparatus according to claim 5, wherein the displaying comprises displaying the at least one customization parameter on a retail website.

9. A computer program, embodied on a non-transitory computer readable medium, the computer program configured to control a processor to perform a process, comprising:
setting at least one customization parameter that describes an aspect of a three dimensional (3D) product that is available to be customized by a customer;
displaying, via a web application, the at least one customization parameter and limits for the at least one customization parameter, wherein the web application is linked to a product file containing a representation of the 3D product;
receiving user selections for the at least one customization parameter;
applying the user selections to the product file to customize the 3D product; and
streaming the product file with the applied user selections to a 3D printer.

10. The computer program according to claim 9, wherein the setting the at least one customization parameter further comprises setting options and extent to which 3D product is able to be customized.

11. The computer program according to claim 9, wherein the at least one customization parameter comprises at least one of scale, color, material, and accessories.

12. The computer program according to claim 9, wherein the displaying comprises displaying the at least one customization parameter on a retail website.
